(19) United States
(12) Patent Application Publication
(10) Pub. No.: US 2009/0260931 A1
(43) Pub. Date: Oct. 22, 2009

(54) FILLER MATERIAL TO DAMPEN VIBRATING COMPONENTS

(75) Inventors: John C. Ulicny, Oxford, MI (US); Michael D. Hanna, West Bloomfield, MI (US); Mark A. Golden, Washington, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/105,438

(22) Filed: Apr. 18, 2008

(51) Int. Cl. F16D 65/12

(52) U.S. Cl. 188/218 XL

(57) ABSTRACT

A component that carries a filler material. The filler material can convert from a solid state and into a molten state when the filler material is heated. Relative movement between the component and the filler material helps dampen vibrations and other oscillations in the component if and when the component is vibrated or otherwise oscillated.

### TECHNICAL FIELD

The field to which the disclosure generally relates includes products and methods used to help dampen vibrations in components, and includes filler materials that are used with components to help dampen vibrations in the components.

### BACKGROUND

Certain components are subjected to various vibrations or other oscillations when in operation. Such vibrations could have undesirable effects such as, among other things, generating noise, having increasing frequency amplitude, or having a prolonged period of vibration modes. Filler materials may be used with the components to help dampen or otherwise dissipate the vibrations.

### SUMMARY OF EXEMPLARY EMBODIMENTS OF THE INVENTION

One exemplary embodiment may include a product which may include a component that carries a filler material. The filler material may convert from a solid state and into a molten state when it is heated. Relative movement between the component and the filler material may help dampen vibrations in the component when the component is vibrated.

Another exemplary embodiment may include a method of making a product. The method may include providing a component that carries a filler material that may be in a solid state when the component is not in operation for a period of time. The method may also include melting the filler material to a molten state when the component is in operation to thus help dampen vibrations and other oscillations in the component if and when the component is vibrated or otherwise oscillated.

Another exemplary embodiment may include a product which may include a brake rotor having a hub portion and a cheek portion that extends from the hub portion. The cheek portion may carry a filler material that converts from a solid state and into a molten state from heat that is generated by the brake rotor when the brake rotor is in operation.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 shows experimental results of several comparative sound intensities at relatively high frequencies when a brake rotor is vibrated of i) the brake rotor without a filler material, ii) the brake rotor with gallium in a solid state, and iii) the brake rotor with gallium in a molten state.

FIG. 2 shows experimental results of several comparative sound intensities at relatively high frequencies when a brake rotor is vibrated of i) the brake rotor with a paraffin wax in a solid state, and ii) the brake rotor with a paraffin wax in a molten state.

FIG. 3 is a schematic showing one example method of making a brake rotor having a chamber with a filler material, and showing, in cross-section, one embodiment of the brake rotor.

FIG. 4 is a schematic showing one example method of making a brake rotor having a chamber with a filler material, and showing, in cross-section, one embodiment of the brake rotor.

FIG. 5 is a schematic showing one example method of making a brake rotor having an insert that holds a filler material.

### DETAILED DESCRIPTION OF EXEMPLARY EMBODIMENTS

The following description of the embodiment(s) is merely exemplary (illustrative) in nature and is in no way intended to limit the invention, its application, or uses.

The figures illustrate a component, such as an automotive component, that uses a filler material 10 to help dampen or otherwise dissipate vibrations or other oscillations in the component. This may help suppress, or reduce the intensity of, sound and noise that is emitted by the component when the component is vibrated at certain frequencies. The automotive component may be any component in an automobile that may be subjected to vibrations such as a brake rotor 12, an electrical motor, a transmission housing, an exhaust manifold, a cylinder head, brackets, or the like. Other components may include non-automotive applications including, but not limited to, sporting equipment, housing appliances, manufacturing equipment such as lathes, milling/grinding/drilling machines, or other components subjected to vibrations. Some of these components may be manufactured by a variety of processes including casting, machining, injection molding, or any other suitable process. In the examples shown, the brake rotor 12 may be subjected to vibrations when a pair of pads (not shown) is forced against the brake rotor by a caliper in order to generate friction that slows or eventually stops the associated automobile. The filler material 10 may also be used in drum brakes, for example, by providing the filler material in a drum brake housing.

Referring to FIGS. 3-5, the brake rotor 12 may be of the solid-type as shown, may be of the vented-type (not shown) having a plurality of the vanes, or may be another type. The brake rotor 12 may include a hub portion 14 and a cheek portion 16 extending from the hub portion. The hub portion 14 may define a central aperture 18 and may also define a plurality of bolt holes 20. The cheek portion 16 may include a first cheek face 22 and an opposite second cheek face 24 that each or together constitute braking or friction surfaces of the brake rotor 12. The brake rotor 12 may be made by a casting process to form its one-piece structure. In select exemplary embodiments, the brake rotor 12 may include iron, titanium, steel, aluminum, magnesium, steel, or any of a variety of other alloys or metal matrix composites. As will be appreciated by skilled artisans, the exact casting process used to form the brake rotor 12, including the number of steps, the order of the steps, the parameters within each step, and the like, may vary among particular components. For instance, the casting process may be a vertical or a horizontal casting process, and may be a sand casting process.

The filler material 10 may be carried by a component, such as the brake rotor 12, to help dampen vibrations and other oscillations in the component when the component is vibrated or otherwise oscillated. In other words, the filler material 10 may help dissipate vibrations, oscillations, and other associated effects in the component through energy absorption. For example, the filler material 10 may help suppress, or reduce the intensity of, sound and noise at certain frequencies. When the component is vibrated, relative movement and other contact at an interface formed between an inner surface located within the component and the filler material 10 absorbs energy, such as vibrations, to consequently dampen the vibrations. The filler material 10 may include a material that converts and changes from a solid state, or phase, and into a molten state, or phase, (e.g. semi-solid liquid, highly viscous liquid) when the material is melted by the generation or application of heat. The heat may be generated by operating the particular component. For example, in the case of the brake rotor 12, the heat may be generated from the braking operation when the pads are forced against the respective first and second cheek faces 22 and 24. In other embodiments, the heat may be produced by heating elements that are located adjacent the filler material 10 within the particular component.

In one example, the filler material 10 may include gallium. In some cases, gallium may convert from its solid state and into its molten state at a temperature that is slightly above room temperature, for example 30° C. (melting temperature). This temperature may be achieved in a particular component by the above-mentioned heating elements or when the component is being operated. For example, the heat generated in the brake rotor 12 and in the cheek portion 16 during the braking operation may be above room temperature and thus would convert the gallium from its solid state into its molten state. In some cases, the gallium may expand (e.g., 3.1%) when it converts from its molten state and into its solid state over a period of time such as when the brake rotor 12 is no longer operated, and thus adequate space may be needed where the gallium is carried in the particular component in order to accommodate for such expansion.

Referring to FIG. 1, the gallium may help suppress noise that is emitted by the vibrating component, such as the brake rotor 12, when the component is vibrated at relatively high frequencies in a range of about 6 to 26 kilohertz (kHz) as compared to a brake rotor without a filler material. Moreover, gallium in a molten state exhibits better noise damping characteristics than gallium in a solid state. The graph of FIG. 1 shows the number of spikes (increased amplitude) of noise intensity that was measured at various sound intensities (70 dB, 80 dB, 90 dB, and 100 dB) when an experimental brake rotor was vibrated between about 6 to 26 kHz. Though not all experiments would render this exact data, the graph shows the general noise damping characteristics of i) a brake rotor without a filler material (e.g., solid), ii) a brake rotor carrying a filler material of gallium in a solid state, and iii) a brake rotor carrying a filler material of gallium in a molten state. For example, molten gallium produces reduced noise intensity of 80 decibels (dB) as compared to solid gallium; and both molten and solid gallium eliminate noise of 90 dB when carried by the brake rotor 12 as the filler material 10. Though not shown in the graph, the gallium may also help suppress noise that is emitted by the vibrating component when the component is vibrated at other frequencies. Moreover, other low melting metals and alloys may be used that may or may not include gallium. For example, a number of solder materials may be used including those supplied by Indium Corporation, New York, U.S.A. (www.indium.com).

In another example, the filler material 10 may include a wax such as, but not limited to, a paraffin wax. Depending on the exact composition, the wax or paraffin wax may convert from its solid state and into its molten state at a temperature between about 47° C. to about 64° C. (melting temperature). These temperatures can be achieved by the above-mentioned heating elements or when the component is being operated. For example, the heat generated from the braking operation to the brake rotor 12 and to the cheek portion 16 may be above these temperatures. In some cases, the wax or paraffin wax may expand when converting from the solid state into the molten state, and thus adequate space may be needed where the paraffin wax is being carried in the particular component in order to accommodate for such expansion.

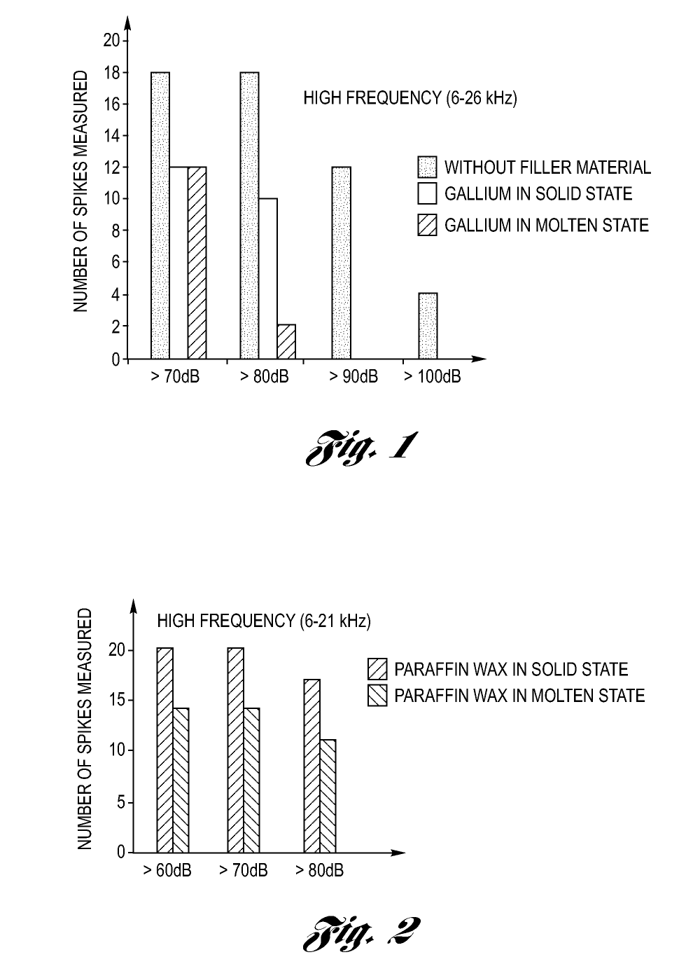

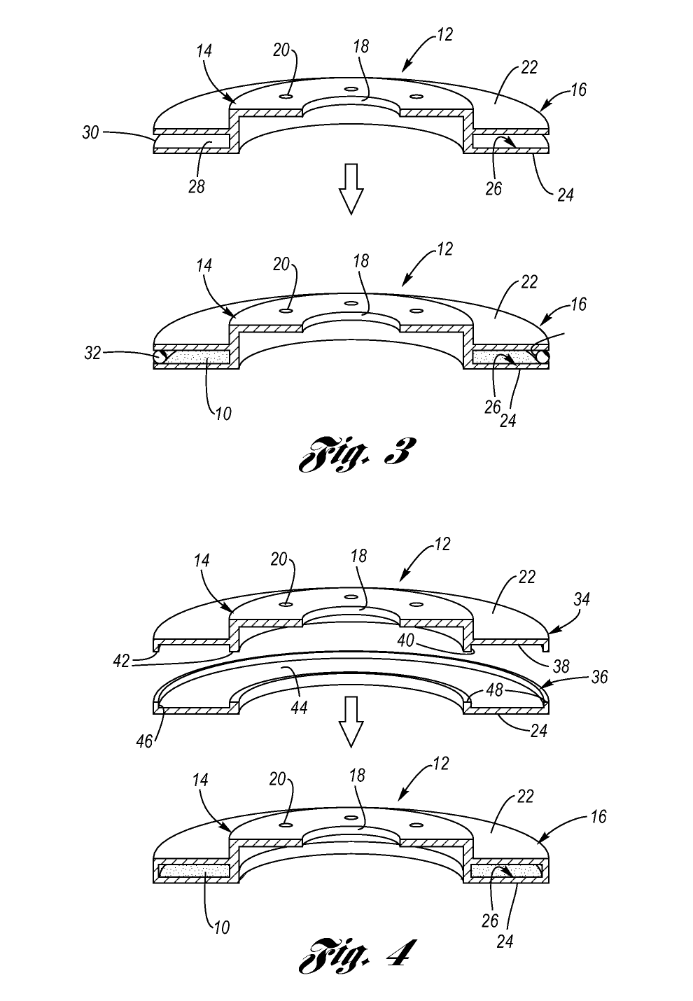

Referring to FIG. 2, the paraffin wax may help suppress noise that is emitted by the brake rotor 12 when the brake rotor is vibrated at relatively high frequencies in a range of about 6 to 21 kHz as compared to a brake rotor without a filler material (not shown). Moreover, molten paraffin wax may exhibit better damping characteristics than solid paraffin wax. The graph of FIG. 2 shows a similar experiment as described for FIG. 1. For example, when the brake rotor 12 is vibrated, the molten wax produces reduced noise intensity of 80 dB as compared to solid wax when used as the filler material 10; the same is true at 70 dB and 60 dB. Though not shown in the graph, the wax may also help suppress noise that is emitted by the vibrating component when the component is vibrated at other frequencies. Moreover, other low melting organic and inorganic compounds with similar melting characteristics as the example wax may be used.

FIGS. 3-5 show several example methods of filling a component with the filler material 10 so that the component can carry the filler material without otherwise melting the material when the component is being cast. Though the examples show the brake rotor 12, the methods may be used in the other previously-mentioned components. And though described with particular steps, skilled artisans will appreciate that the exact process used in the methods, including the number of steps, the order of the steps, the parameters within each step, and the like, may vary among particular components and may depend on, among other things, the materials used for the component, the material used for the filler material, or both.

FIG. 3 shows one example method that may be used to form a chamber 26 that can be used to carry and completely confine the filler material 10 within the brake rotor 12. A cavity or slot 28 may be cut or otherwise machined in the cheek portion 16. The slot 28 may be circumferentially continuous in the cheek portion 16, may be rectangular in cross-sectional profile, and may form a circumferentially continuous open end 30 in the cheek portion 16. The filler material 10 may then be filled or otherwise put in the space defined by the slot 28. The open end 30 may be closed and sealed to thus enclose the slot 28 and to form the chamber 26. One way of closing and sealing the open end 30 is to place a wire such as a copper wire 32, a solder, or other suitable fusible metal adjacent and continuously around the open end 30, and to subsequently fuse the copper wire thereat to completely confine the chamber 26 by the cheek portion 16.

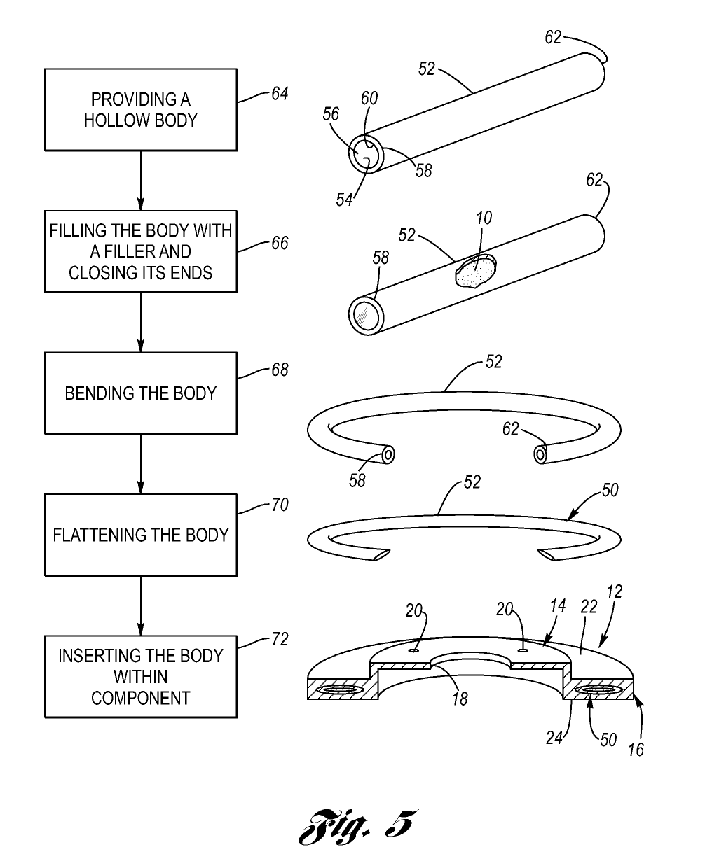

FIG. 4 shows another example method that may be used to form the chamber 26 in the brake rotor 12 in order to carry and completely confine the filler material 10. A first portion 34 and a second portion 36 may each be cast as separate components. The first portion 34 may define a first cavity 38 that is circumferentially continuous and somewhat rectangular in cross-sectional profile. The first cavity 38 may have a first open end 40 that is bounded by a first periphery 42. The second portion 36 may define a second cavity 44 that may be complementary in shape and size to the first cavity 38. The second cavity 44 may have a second open end 46 that is bounded by a second periphery 48. The filler material 10 may then be filled in or otherwise put in the space defined by the first cavity 38, the space defined by the second cavity 44, or both. The first and second portions 34 and 36 may be joined and sealed by welding at an interface at the first and second peripheries 42 and 48 when the portions are brought together. The first and second cavities 38 and 44 then form the single chamber 26.

Other example methods that may be used to form the chamber 26 are not necessarily shown. For example, a sacrificial insert may be used. The sacrificial insert would be shaped and sized according to the desired shape and size of the particular chamber 26, and would be composed of a material that could withstand (i.e., not melt at) the temperature of the molten component material of the particular component during casting. The sacrificial insert would be positioned in a die of a cast molding machine in order to create the chamber 26 in a desired position in the particular component. After the molten component material is poured, the sacrificial insert may be removed, for example, by etching or machining, and thus leaving the chamber 26.

In all the above methods, the chamber 26 may define an enclosed space that is completely confined by and bounded by the particular component. The chamber 26 may have various shapes, sizes, and numbers other than those shown in order to accommodate different components. For example, several separate chambers may be defined at separate locations in a component in order to dampen vibrations at those locations.

FIG. 5 shows one example of an insert 50 that may be used to carry the filler material 10, and shows one example method that may be used in order to form the insert 50. The insert 50 may have various shapes, sizes, and numbers other than those shown in order to accommodate different components. For example, several rectangular inserts may be inserted at separate locations in a component in order to dampen vibrations at those locations. The figure shows one example for use with the brake rotor 12 where the insert 50 has a generally tubular or cylindrical shape that is eventually formed into an open ring shape having a generally oval cross-sectional profile. When in use, the insert 50 may be located completely within and bounded by the particular component, such as is shown in the example brake rotor 12. In other examples, the insert 50 may be only partially located within a component, or otherwise be exposed out of a component and still dampen vibrations. That is, an outside surface of the insert 50 may be exposed and may be flush with an outside surface of a component where the insert would be an inlay.

A body 52 may form the outer structure of the insert 50 and may encase the filler material 10. In the example shown, the body 52 may completely enclose the filler material 10. In select exemplary embodiments, the body 52 may include various materials including cast iron, gray cast iron, aluminum, magnesium, steel, stainless steel, and any other variety of other alloys or metal matrix composites. The body 52 may define a cavity 54 having an inner surface 56 to hold the filler material 10 therein. The cavity 54 may extend from a first end 58, which defines a first opening 60, to a second end 62, which defines a second opening (not shown). The first and second openings may be closed to seal the filler material 10 within the cavity 54 by various techniques including stamping, plugging, welding, or the like.

The example method may be used to manufacture the insert 50 and subsequently insert it into the brake rotor 12. The method may comprise several steps including a step 64 where the body 52 may be provided as an elongated hollow body that may be formed by casting, machining, or the like. In a step 66, the body 52 and the cavity 54 may be filled with the filler material 10, and the first and second openings may be closed. Here, the body 52 may be completely or partially filled with a filler material 10. In a step 68, the body 52 may be bent into a desired shape such as the open ring-shape shown here; in some embodiments, this step may not be needed. Skilled artisans will know suitable bending processes such as the roll-type bending process. In a step 70, the body 52 may be at least partially flattened so that the body will fit within the particular component. Here, the body 52 may be flattened to have an oval shape in cross-sectional profile so that the insert 50 can fit in the cheek portion 16 of the brake rotor 12; in some embodiments, this step may not be needed. Skilled artisans will know suitable flattening processes including a stamping process, a pressing process, and the like. In a step 72, the insert 50 is inserted into the particular component. Here, the insert 50 may be cast-in-place to be completely within and completely bounded by the cheek portion 16 of the brake rotor 12. Such cast-in-place processes may be performed by using locating pins, clamps, magnets, and the like to suspend and position the insert 50 within the cheek portion 16. The body 52 may also be fixed to the component by welding, by adhesive, or by injection molding. Alternatively, the body 52 with the filler material 10 may be placed in a component in a manner that allows the body to move so that the movement of the body against the component also helps dampen the component.

The above description of embodiments of the invention is merely exemplary in nature and, thus, variations thereof are not to be regarded as a departure from the spirit and scope of the invention.

What is claimed is:

1. A product comprising:
a component carrying a filler material, the filler material converting from a solid state and into a molten state with the application of heat during operation of the component, wherein relative movement between the component and the filler material helps dampen vibrations in the component when the component is vibrated.

2. A product as set forth in claim 1 wherein, when the filler material is in the molten state, the filler material helps reduce the intensity of sound that is emitted by the vibrating component when the component is subjected to frequencies in a range of at least about 6 to 21 kilohertz (kHz).

3. A product as set forth in claim 1 wherein the filler material comprises gallium that, when in a molten state, helps reduce the intensity of sound that is emitted by the vibrating component when the component is subjected to frequencies in a range of about 6 to 26 kilohertz (kHz).

4. A product as set forth in claim 1 wherein the filler material comprises wax that, when in a molten state, helps reduce the intensity of sound that is emitted by the vibrating component when the component is subjected to frequencies in a range of about 6 to 21 kilohertz (kHz).

5. A product as set forth in claim 1 wherein the filler material is carried by the component such that the filler material is completely confined by and sealed within the component.

6. A product as set forth in claim 1 wherein the component is a brake rotor comprising a cheek portion and a hub portion extending from the cheek portion, the filler material being carried within the cheek portion, and wherein the filler material converts from the solid state and into the molten state when the brake rotor is heated by being subjected to a braking operation.

7. A product as set forth in claim 6 wherein the filler material is gallium that, when in a molten state, helps reduce the intensity of sound that is emitted by the vibrating brake rotor when the brake rotor is subjected to frequencies in a range of about 6 to 26 kilohertz (kHz).

8. A product as set forth in claim 6 wherein the filler material comprises a paraffin wax that, when in a molten state, helps reduce the intensity of sound that is emitted by the vibrating brake rotor when the brake rotor is subjected to frequencies in a range of about 6 to 21 kilohertz (kHz).

9. A method of making a product, the method comprising:
providing a component carrying a filler material that is in a solid state when the component is not operating for a period of time; and
melting the filler material to a molten state when the component is operating to help dampen vibrations in the component when the component is vibrated.

10. A method as set forth in claim 9 wherein melting the filler material helps reduce the intensity of sound that is emitted by the vibrating component when the component is subjected to frequencies in a range of at least about 6 to 21 kilohertz (kHz).

11. A method as set forth in claim 9 wherein providing the filler material further comprises providing the filler material comprising gallium, and wherein melting the filler material helps reduce the intensity of sound that is emitted by the vibrating component when the component is subjected to frequencies in a range of about 6 to 26 kilohertz (kHz).

12. A method as set forth in claim 9 wherein providing the filler material further comprises providing the filler material comprising a wax, and wherein melting the filler material helps reduce the intensity of sound that is emitted by the vibrating component when the component is subjected to frequencies in a range of about 6 to 21 kilohertz (kHz).

13. A method as set forth in claim 9 wherein melting the filler material further comprises generating heat in the component.

14. A method as set forth in claim 13 wherein generating heat further comprises generating heat during operation of the component.

15. A method as set forth in claim 9 wherein providing the component further comprises providing the component being a brake rotor having a cheek portion and a hub portion extending from the cheek portion, and the filler material being carried within the cheek portion.

16. A method as set forth in claim 15 wherein providing the filler material further comprises providing the filler material comprising gallium, and wherein melting the filler material helps reduce the intensity of sound that is emitted by the vibrating component when the component is subjected to frequencies in a range of about 6 to 26 kilohertz (kHz).

17. A method as set forth in claim 15 wherein providing the filler material further comprises providing the filler material comprising a paraffin wax, and wherein melting the filler material helps reduce the intensity of sound that is emitted by the vibrating component when the component is subjected to frequencies in a range of about 6 to 21 kilohertz (kHz).

18. A product comprising:
a brake rotor comprising:
a hub portion; and
a cheek portion extending from the hub portion and carrying a filler material, the filler material converting from a solid state and into a molten state by heat generated when the brake rotor is operated.

19. A product as set forth in claim 18 wherein, when the filler material is in the molten state, the filler material helps reduce the intensity of sound that is emitted by the vibrating component when the component is subjected to frequencies in a range of at least about 6 to 21 kilohertz (kHz).

20. A product as set forth in claim 18 wherein the filler material comprises gallium that, when in a molten state, helps reduce the intensity of sound that is emitted by the vibrating component when the component is subjected to frequencies in a range of about 6 to 26 kilohertz (kHz).

21. A product as set forth in claim 18 wherein the filler material comprises a paraffin wax that, when in a molten state, helps reduce the intensity of sound that is emitted by the vibrating component when the component is subjected to frequencies in a range of about 6 to 21 kilohertz (kHz).
